(19) United States
(12) Patent Application Publication
(10) Pub. No.: US 2014/0263667 A1
(43) Pub. Date: Sep. 18, 2014

(54) ARTICLES DISPLAYING TWO DIMENSIONAL BARCODES

(71) Applicant: LEON MEGE INC., New York, NY (US)

(72) Inventor: Leon Mege, New York (NY)

(73) Assignee: LEON MEGE INC., New York, NY (US)

(21) Appl. No.: 13/834,240

(22) Filed: Mar. 15, 2013

(51) Int. Cl. G06K 19/06

(52) U.S. Cl. CPC G06K 19/06159; G06K 19/06037
USPC 235/494; 148/240

(57) ABSTRACT

An article displaying a two dimensional barcode is disclosed, the article including a metal piece with an exterior surface having one or more recesses, where the recessed metal is tarnished so that is contrasts with the than the exterior surface color and the one or more recesses are shaped, sized and positioned to visually display a two-dimensional barcode. In addition, an article of jewelry displaying a two dimensional barcode is disclosed, the jewelry including a metal piece having recesses displaying a two-dimensional barcode and a wearing attachment for wearing the jewelry. Moreover, a process is disclosed including casting a metal piece to have one or more recesses, tarnishing the metal piece, and removing the tarnish from the non-recessed exterior surface so the recessed metal contrasts the color of the metal's exterior surface and visually displays a two-dimensional barcode.

### FIELD OF THE INVENTION

This invention relates to articles displaying a two dimensional barcode. In particular, this invention relates to a metal piece displaying a two dimensional barcode, an article of jewelry displaying a two dimensional barcode and a process for making such articles.

### BACKGROUND

The use of barcodes to encode information is widely known. Traditional barcodes visually represented machine readable data by using vertical lines with varying widths and spacings between them. More recently, use of other geometric shapes and patterns across the vertical and horizontal planes have been used to provide two-dimensional barcodes. In addition to providing the capability to encode greater amounts of information, two-dimensional barcodes utilize intricate visual patterns that are appealing to the eye. At the same time they can convey useful information, but only when read with a scanning device and not through visual inspection alone.

Typically, two-dimensional barcodes are printed on paper or other flat surfaces and utilize black and white colors. By utilizing a three dimensional object, however, it would be possible to further enhance the visual appeal of a two-dimensional barcode, especially if the object itself was made of a visually appealing material. Thus, it would be desirable to produce articles that can display two-dimensional barcodes to convey information in a unique manner that further enhances the visual appeal of the overall article.

It is an object of the invention to provide articles and processes that, amongst other features and advantages, address these objectives. It is an object of certain embodiments of the invention to provide an article displaying a two-dimensional barcode. It is an object of certain other embodiments of the invention to provide an article of jewelry displaying a two-dimensional barcode. It is an object of still other embodiments of the invention to provide a process for producing such articles. These and other objects, features and advantages of the invention or of certain embodiments of the invention will be apparent to those skilled in the art from the following disclosure and description of exemplary embodiments.

### SUMMARY

In accordance with one aspect of the invention an article displaying a two dimensional barcode is disclosed, the article comprising a metal piece comprising an exterior surface, wherein the exterior surface has an exterior color, and one or more recesses in the exterior surface, wherein the recessed metal is tarnished such that it has a visual appearance that contrasts with the exterior color. In this aspect, the one or more recesses are shaped, sized and positioned in the exterior surface such that the contrast between the exterior surface of the metal and the tarnished recess metal visually displays a two-dimensional barcode on the metal piece.

In certain exemplary embodiments, the metal piece has a depth and the one or more recesses comprise a first side surface forming a ninety degree angle with the exterior surface and extending into the metal piece a distance equal to about a third of the depth of the metal piece, and a bottom surface forming a ninety degree angle with the first side surface. In some embodiments the metal piece is a silver alloy. In certain embodiments, the recessed metal is tarnished to the degree that it is black, grey or a combination thereof in color. In some exemplary embodiments, the metal piece is cast from a mold shaped and sized to provide a casted metal piece comprising the flat exterior surface and the one or more recesses. In certain embodiments, the exterior surface is flat. In various embodiments, the two-dimensional barcode is a QR code.

Other aspects of the invention relate to an article of jewelry displaying a two dimensional barcode, the article of jewelry comprising a casted metal piece, the metal piece comprising an exterior surface that has an exterior color. In these aspects of the invention, the article of jewelry also comprises one or more recesses in the exterior surface and the recessed metal is tarnished such that it has a visual appearance that contrasts with the exterior color. In these aspects of the inventions, the article of jewelry also comprises a wearing attachment connected to the metal piece that allows a person to wear the article of jewelry and the one or more recesses are shaped, sized and positioned in the exterior surface such that the contrast between the exterior surface of the metal and the tarnished recess metal visually displays a two-dimensional barcode on the metal piece.

In some exemplary embodiments, the one or more recesses comprise a first side surface forming a ninety degree angle with the exterior surface and extending into the metal piece, and a bottom surface forming a ninety degree angle with the first side surface. In certain embodiments, the metal piece has a depth, and the first side surface extends into the metal piece a distance equal to about a third of the depth of the metal piece.

In various exemplary embodiments, the metal piece is a silver alloy. In certain embodiments, the exterior surface of the article of jewelry is flat. In some embodiments, the recessed metal is tarnished to the degree that it is black, grey or a combination thereof in color. In certain embodiments, the recessed metal is tarnished to the degree that it is green, teal, blue, purple, black, grey or a combination thereof in color.

In yet another aspect of the invention, a process is disclosed, the process comprising casting metal in a mold shaped and sized to provide a casted metal piece comprising a flat exterior surface and one or more recesses in its exterior surface, where the exterior surface has an exterior color. The process further comprises tarnishing the metal piece and removing the tarnish from the non-recessed exterior surface such that the recessed metal has a visual appearance that contrasts with the color of exterior surface, and so where the one or more recesses are shaped, sized and positioned in the exterior surface such that the contrast between the exterior surface of the metal and the tarnished recess metal visually displays a two-dimensional barcode on the metal piece.

In some exemplary embodiments, the process further comprises receiving content information from a buyer and converting the content information into a two-dimensional barcode, and where the metal is cast in a mold shaped and sized such that, at the completion of the process, the metal piece will visually display a two-dimensional barcode encoding the content information. In certain embodiments, the process further comprises printing the mold from a 3D printer. In some embodiments, the metal piece is tarnished by exposing it to a solution containing sulfur. In various embodiments, the two-dimensional barcode is a QR code. In certain embodiments, the metal piece has a depth, and the one or more recesses comprise a first side surface forming a ninety degree angle with the exterior surface and extending into the metal piece a distance equal to about a third of the depth of the metal piece, and a bottom surface forming a ninety degree angle with the first side surface.

### BRIEF DESCRIPTION OF THE DRAWINGS

Exemplary embodiments of the disclosure will now be described by way of example only and with reference to the accompanying drawings, in which:

FIG. 1 shows an exemplary embodiment of an article displaying a two dimensional barcode.

FIGS. 2A and 2B show exemplary embodiments of articles displaying a two dimensional barcode and having an additional visually appealing feature.

FIG. 3 shows a zoomed-in view of a portion of the exemplary embodiment from FIG. 1. The features of this figure are not necessarily to scale and are meant to assist a skilled artisan understand certain aspects of the exemplary embodiment.

FIGS. 4A-4F show zoomed-in side views of exemplary embodiments of the recesses in the metal piece.

FIGS. 5a and 5b show two views of an exemplary embodiment of a mold used to cast an article displaying a two dimensional barcode.

### DETAILED DESCRIPTION OF EMBODIMENTS

The embodiments, apparatuses and methods described herein provide articles displaying a two dimensional barcode, articles of jewelry displaying a two-dimensional barcode, and processes for making such articles. These and other aspects, features and advantages of the invention or of certain embodiments of the invention will be further understood by those skilled in the art from the following description of exemplary embodiments.

One aspect of the invention relates to an article that comprises a metal piece displaying a two dimensional barcode. In some embodiments, the entire article is made from a single piece of metal that has been casted to have one or more recesses. The metal piece may be any geometric or non-geometric shape, including triangles, squares, rectangles, circles or polygons. In other exemplary embodiments, the metal piece is shaped and sized like a dog tag or a heart. In some embodiments, the metal piece has a relatively small depth when compared to the width and/or length dimensions of the metal piece, while in others the depth is relatively close to or equal to the width and/or length dimensions of the metal piece, including embodiments where the metal piece is a cube. In certain embodiments, a single surface or face of the metal piece has the one or more recesses, while in others multiple surfaces or faces have one or more recesses. In some embodiments, every surface or face has one or more recesses.

The metal piece may be any size that can display a two dimensional barcode readable by a scanning device when the scanning device is oriented at the appropriate angle and an appropriate distance from the metal piece to view the barcode. As used herein, the term “scanning device” includes any device having an image sensor and a processor capable of running a program that can digitally analyze and decode the two-dimensional image, including mobile smartphones. As used herein, when an article visually displays a barcode “readable by a scanning device,” this means the article displays two or more colors that, if arranged to display a QR barcode, the QR barcode is capable of being read by at least an iPhone® 5 running the freely available iPhone® application “Scan.” This definition is solely to assist a skilled artisan understand the scope of this disclosure, which is not limited to QR codes but, as described below, extends to many types of two dimensional barcodes.

In some embodiments, the length and width of the metal piece are approximately 20 millimeters, while in others the length and width are between approximately 20 and approximately 50 millimeters, or between approximately 30 and approximately 40 millimeters. In some embodiments, where the depth of the metal piece is relatively small compared to the length and/or width, resulting in a metal piece that somewhat resembles a two dimensional object, the depth of the metal piece is approximately 1.5, 1.75 or 2.0 millimeters. In various other embodiments the depth is approximately 20 millimeters, while in others the depth is between approximately 20 and approximately 50 millimeters, or between approximately 30 and approximately 40 millimeters. In some embodiments, the metal piece is much larger, having one or more dimensions of approximately 75 millimeters or more, approximately 100 millimeters or more, approximately 150 millimeters or more or approximately 200 millimeters or more.

The one or more recesses present on the metal piece have a sufficient depth that processes that will remove tarnish from the exterior surface, such as polishing, will not significantly affect the recessed metal material. In some embodiments, depth of the recessed material is approximately 0.3, 0.4 or 0.5 millimeters. In other embodiments, the depth is approximately 0.75, 1.0, 1.5 or 2 millimeters. In still others, it is approximately 5, 7.5 or 10 millimeters. In some exemplary embodiments, the depth of the recess is approximately one tenth, one quarter or one third of the depth of the metal piece.

The metal used for the metal piece may be any metal element or alloy that is capable of tarnishing, e.g. oxidizing or the forming a patina, such that the color or appearance of the tarnished metal changes to form a contrast with non-tarnished metal. In some embodiments, the metal used is silver, copper, aluminum, zinc, nickel or alloys thereof. Due to its relatively high susceptibility to tarnishing, some embodiments use pure copper or metal alloys made with copper. In certain embodiments, the metal piece is made from a silver alloy such as sterling silver, a copper alloy such as bronze or brass, or a gold alloy, including gold alloys made with copper and/or silver and being 8, 10 or 14 carat gold. The exterior surface of the metal has a color. In some embodiments, the exterior color is the color of the type of metal or alloy in its clean, non-tarnished state. In other embodiments, the exterior color of the surface is the color of the metal or alloy in a tarnished state.

As discussed in more detail below when addressing the aspects of the invention relating to a process for making these articles, the metal piece is treated so that the recessed material has a contrasting color compared to the exterior surface. In some embodiments, the entire metal piece is tarnished and then the tarnish is removed from the exterior surface. In one exemplary embodiment, a sterling silver metal piece is exposed to a sulfur containing solution until the entire piece turns black, and then the tarnish is completely removed from the exterior surface. This results in a metal piece with a silver exterior surface and one or more recesses with the contrasting black color. Regardless of the metal or alloy used, when the one or more recesses are shaped, sized and positioned appropriately in the exterior surface, the contrast between the exterior surface of the metal and the tarnished recess metal can visually display a two-dimensional barcode on the metal piece. By placing the barcode on a three dimensional object made from a single piece of metal, the article advantageously displays the two dimensional barcode in a visually appealing manner, especially in the embodiments that have no other materials in addition to the metal piece. The article's streamlined design can also provide appealing tactile properties due to the interplay of recessed surfaces with the exterior surface. Furthermore, by using a single piece of metal, the article is extremely durable and will retain its visual properties and readability for extended periods.

FIG. 1 shows an exemplary embodiment of an article displaying a two dimensional barcode, the embodiment including a metal piece 10 having a flat exterior surface 11. In this embodiment, the exterior surface 11 has a plurality of recesses 12. In certain embodiments, the exterior surface is curved, has additional raised areas, or a combination thereof. In these embodiments, the curvature of the surface is small enough in magnitude that a scanning device can still read the two dimensional code and any raised areas on the exterior surface are positioned, shaped and sized such that a scanning device can still read the two dimensional code. In the embodiment of FIG. 1, the metal in the recesses 12 has been tarnished to have a much darker color than the color of the exterior surface 11. The contrast between these colors and the shape, size and position of the recesses in the exterior surface is such that the metal piece 10 as a whole visually displays a two-dimensional barcode.

In this exemplary embodiment, the metal piece 10 displays a QR code that encodes a URL. In some embodiments, regardless of what type of two dimensional barcode is used, the code may encode contact information, a private message, text, numerical information, a URL or any other information capable of being converted to a readable two dimensional-code. In certain embodiments, a user or buyer can specify what information the two-dimensional barcode encodes. Any two dimensional barcode using utilizing two colors may be used, including but not limited to ShotCode, SPARQCode, Aztec code, MaxiCode, Data Matrix, or EZ Code.

In some embodiments, in addition to the two-dimensional code the metal piece has one or more other visually appealing elements made from the contrasting appearance of the recessed metal and the exterior surface metal. FIGS. 2A and 2B show some of these exemplary embodiments. In these embodiments, metal pieces 20a and 20b display the same QR code displayed in FIG. 1 through the contrast between the exterior surfaces 21 and recesses 22, but there is an additional visual element 23a or 23b. As two-dimensional barcode scanners are capable of correcting for any errors caused by the additional visual element, metal pieces 20a and 20b still display a readable code encoding the desired information, yet beneficially have additional visually appealing elements that can appeal to consumers or convey additional information. The one or more additional visually appealing elements can be any design, decoration, emblem, logo, drawing, text or a combination thereof that can fit on the metal piece. In certain embodiments, the one or more additional visually appealing element may simply be a section of the exterior surface with no recessed metal. In some embodiments, the one or more additional visually appealing elements is not made by recessed metal having a tarnished, contrasting appearance, but rather is added through other processes, such as painting or adhering other objects to the exterior surface. In certain embodiments, the additional element comprises metal plating, precious stones or facsimiles thereof, or beads.

FIG. 3 shows a zoomed in view of a portion of the exemplary embodiment of FIG. 1, where the features of the one or more recesses are exaggerated for clarity. Although some embodiments of the article may have the relative scale shown in FIG. 3, this scale is illustrative. In this exemplary embodiment, the exterior surface 31 and a plurality of recesses 32 combine to display the two-dimensional code. Each recess has at least one exterior edge 33 and a first side surface 34, where the side surface 34 extends into the depth of the metal piece. In this exemplary embodiment, there is a ninety degree angle between the exterior surface 31 and the first side surface 34, and the first side surface 34 extends a distance equal to approximately one third of the depth of the metal piece. In this exemplary embodiment, the recess has a bottom edge 35 and a bottom surface 36 with a ninety degree angle between them, as well as a plurality of additional side surfaces 37 that extend from the bottom surface 36 back up to the exterior surface 31.

The one or more recess may be formed with a variety of shapes, angles and number of surfaces. FIGS. 4A-4F illustrate other exemplary embodiments of the one or more recesses. As shown in FIG. 4A and described above, the recess may have edges, side surfaces and a bottom surface with ninety degree angles between them. In the exemplary embodiment of FIG. 4B, there is no bottom surface, but rather two side surfaces that extend towards each other to form a “V” shape. In the exemplary embodiment of FIG. 4C, the recess only has a single curved surface. In the exemplary embodiment of FIG. 4D, the recess has two side surfaces that form obtuse angles with the exterior surface and a bottom edge parallel with the exterior surface between them. In the exemplary embodiment of FIG. 4E, there are two side surfaces that form acute angles with the exterior surface and a bottom surface between them, which can further enhance the visual and tactile appeal of the article as it appears to “float” above the recessed material. Similarly, in the exemplary embodiment of FIG. 4F, there are side surfaces that curve away from the exterior edge. Any combination of number of surfaces, shapes and angles may be used as long as all the material of the recess is physically separated from the exterior surface to the degree that removing any tarnish from the exterior surface will essentially leave the tarnish of all the recessed metal intact.

As discussed in more detail below when addressing the aspects of the invention relating to a process for making these articles, the metal of the one or more recesses may have a wide variety of visual characteristics based on the metal or alloy used and the conditions under which the metal is treated. In some embodiments, the metal of the one or more recesses is tarnished until it is black, grey, or a combination thereof in color. In certain embodiments, the metal of the one or more recesses is tarnished until it is red, crimson, green, teal, blue, purple, brown, black, grey or a combination thereof. In some embodiments, the exterior surface is also tarnished such that it has one or more of these colors provided it still contrasts with the metal of the one or more recesses to the degree that the article displays a barcode readable by a scanning device.

For example, by varying the conditions of the tarnishing treatment, a silver alloy such as sterling silver can be lightly tarnished to the degree that its surface is crimson, green, teal, blue, purple or a combination thereof. Areas of the silver alloy that are more heavily tarnished will turn grey, black or a combination thereof. In another exemplary embodiment, a copper metal piece or copper alloy such as bronze or brass can be tarnished to the degree that its surface becomes brown, dark brown or black, and areas with a more significant degree of tarnishing become teal or a very light green.

If the tarnish is removed from certain areas of the metal piece, such as the exterior surface, a visual contrast exists between the colors of the tarnished and non-tarnished areas of the metal piece such that a scanning device can differentiate between the two colors. In one exemplary embodiment, a metal piece made of a silver alloy is tarnished until it is black, the tarnish is removed from the exterior surface, and the resulting silver exterior and black recess area or areas contrast sufficiently that a scanning device can differentiate them. When the recess area or areas are shaped, sized and positioned appropriately on the silver alloy piece, as in the exemplary embodiment shown in FIG. 1, the piece visually displays a two dimensional barcode readable by a scanning device.

In another exemplary embodiment, the visual contrast is formed between a silver exterior and tarnished recess area or areas that are crimson, green, teal, blue, purple or a combination thereof. In yet another exemplary embodiment, the visual contrast is formed on a gold alloy piece between a gold exterior surface and a recess area or areas that are brown, black, or a combination thereof. In still another exemplary embodiment, the visual contrast is formed on a copper or copper alloy piece between a copper colored exterior surface and a recess area or areas that are light green. In one exemplary embodiment, the visual contrast is formed on a copper or copper alloy piece between a copper colored exterior surface and a recess area or areas that are brown, black or a combination thereof. In some exemplary embodiments, the exterior surface is retarnished to a different degree than the recessed areas, for example when the visual contrast is formed on a copper or copper alloy piece between a recess area or areas that have been tarnished until they are light green, blue, teal, purple, or a combination thereof, and after this tarnish is removed from the exterior surface the exterior surface is retarnished until it is brown, black, or a combination thereof.

In some exemplary embodiments, the article further comprises a lacquer applied to part or all of the metal piece. In certain exemplary embodiments, the lacquer is applied to the recessed area or areas to prevent or slow future tarnishing, thus preserving the recessed metal in its current state. For example, applying a lacquer to the recess areas of a metal piece made of a silver alloy when they have been tarnished to be crimson, green, teal, blue, purple or a combination thereof in color will limit or prevent further tarnishing by exposure to air over time to a darker color of grey, black, or a combination thereof. This can extend the time period the article will display the two dimensional barcode using an appealing color contrast. In certain other embodiments, the entire metal piece is covered in a lacquer to slow or prevent future tarnishing to any portion of the metal piece.

In certain embodiments, a polyurethane lacquer covers some or all of the metal piece. In others, the lacquer comprises cellulous nitrate or an acrylic thermoplastic resin. In certain embodiments, the lacquer is Paraloid B-72, Incralac or Agateen Lacquer #27.

These descriptions of the article are merely exemplary. In certain embodiments, the article comprises additional combinations or substitutions of some or all of the components described above. Moreover, additional and alternative suitable variations, forms and components for the article will be recognized by those skilled in the art given the benefit of this disclosure.

Another aspect of the invention relates to an article of jewelry displaying a two dimensional barcode. In one exemplary embodiment, the article of jewelry comprises the article displaying a two-dimensional barcode described above, including all of the article embodiments described above and articles that comprise additional combinations or substitutions of some or all of the components described above. In certain embodiments, the article of jewelry further comprises a wearing attachment connected to the article.

In some embodiments, the article of jewelry comprises a casted metal piece comprising an exterior surface that has an exterior color, one or more recesses in the exterior surface where recessed metal is tarnished such that it has a visual appearance that contrasts with the exterior color and a wearing attachment connected to the metal piece allowing a person to wear the article of jewelry, where the one or more recesses are shaped, sized and positioned in the exterior surface such that the contrast between the exterior surface of the metal and the tarnished recess metal visually displays a two-dimensional barcode on the metal piece.

In some embodiments, the article of jewelry is a ring, pendant, locket, charm, bracelet, anklet, necklace, earring, dog tag, cuff link, hairpin, or brooch. In certain embodiments, the article of jewelry further comprises other decorative features such as metal plating, precious stones or facsimiles thereof, beads, shells, a gilded frame, or a combination thereof. In some embodiments, the wearing attachment comprises the structural features typically utilized by these types of jewelry. For example, in certain embodiments the article of jewelry is a dog tag and the wearing attachment is a chain sized to go around the wearer's neck. In another exemplary embodiment, the article of jewelry is an earring and the wearing attachment is an ear clip, corresponding magnets or a thin metal piece designed to go through a pierced ear lobe. In still another exemplary embodiment, the article of jewelry is a ring and the wearing attachment is a band or shank. In other exemplary embodiments, the wearing attachment is a clip, hook, or fastener. Given the benefit of these representative examples, a skilled artisan would readily understand the features of the wearing attachment for these types of jewelry.

In certain embodiments, the entire article of jewelry is made from a single piece of metal, meaning the metal piece bearing the two-dimensional barcode and the wearing attachment are simply different features of the same piece of metal. In some embodiments, only the recessed metal is tarnished, while in others the additional metal of the wearing attachment is also tarnished as long as the portion of the exterior surface surrounding the one or more recesses displays a contrasting color. In one exemplary embodiment, a bracelet made of a silver alloy may be entirely tarnished such that it is red, crimson, green, teal, blue, purple, or a combination thereof in color, except for the portions of the metal adjacent to any recess, meaning the bracelet still displays a two dimensional barcode readable by a scanning device. In this exemplary embodiment, the wearing attachment is the portions of the metal piece that extend from the area displaying the barcode, and that are shaped and sized to go around a wearer's wrist.

These descriptions of the article of jewelry are merely exemplary. In certain embodiments, the article of jewelry comprises additional combinations or substitutions of some or all of the components described above. Additional and alternative suitable variations, forms and components for the article of jewelry will be recognized by those skilled in the art given the benefit of this disclosure. Moreover, any of the features discussed in the exemplary embodiments of the article displaying a two dimensional barcode may be features of embodiments of the article of jewelry described above, and vice versa, as well as additional combinations or substitutions of some or all of the components described for either article.

Another aspect of the invention relates to a process. In some embodiments, the process relates to the manufacture of an article displaying a dimensional barcode. In certain embodiments, the process relates to the manufacture of an article of jewelry displaying a barcode. The products of these processes may have any of the features described above for the article displaying a two dimensional barcode, the article of jewelry, or any combination thereof.

In some embodiments, the process comprises casting a piece of metal in a mold shaped and sized to provide a casted metal piece comprising an exterior surface and one or more recesses in its exterior surface, tarnishing the metal piece, and removing the tarnish from the non-recessed exterior surface such that the recessed metal has a visual appearance that contrasts with the color of exterior surface, and where the one or more recesses are shaped, sized and positioned in the exterior surface such that the contrast between the exterior surface of the metal and the tarnished recess metal visually displays a two-dimensional barcode on the metal piece.

FIG. 5 shows two views of an exemplary embodiment of a mold 50 used to cast an article displaying a two-dimensional barcode, where FIG. 5A shows the mold from above and FIG. 5B shows a perspective view. In this exemplary embodiment of the mold, a metal piece cast from the mold will have recesses that, when contrasting with the exterior color of the metal, will display the QR code shown in FIG. 1. In this exemplary embodiment, the mold has a plurality of raised portions 51 that result in a casted metal piece having a plurality of corresponding recesses, as shown by the plurality of recesses 12 in FIG. 1.

Any casting technique appropriate for the desired metal or alloy may be used. In some embodiments, the metal is cast using sand casting, lost-wax casting or investment casting, lost foam casting, full-mold casting, ceramic casting, rubber casting, plaster casting, die casting, or centrifugal casting.

In certain embodiments, the metal is cast in a mold made by a 3D printer. In some embodiments the 3D printed mold is made from wax. These embodiments advantageously allow the rapid production of custom molds, including custom molds that can result in articles of jewelry made entirely by a single piece of metal. In other embodiments, the 3D printer mold is made from plastic, silicone, sand, ceramic, or a liquid resin. Other embodiments may use any other material that can be deposited by a 3D printer or connected by binder material deposited by a 3D printer. In still other embodiments, the metal piece is not casted in a mold but is formed directly by a 3D printer. In some of these embodiments, the metal piece is printed using fused deposition modeling or direct metal laser sintering.

In embodiments of the process using a 3D printer, regardless of whether the printer makes a mold or the metal piece itself, a computer aided design program takes an image of a two-dimensional barcode and creates an appropriate three dimensional model corresponding to the image. In some embodiments, the three dimensional model corresponds to the mold needed to cast a metal piece having recessed areas configured to display the two-dimensional barcode. In others the three dimensional model corresponds to the metal piece having recessed areas configured to display the two-dimensional barcode. In some embodiments, the computer aided design program is Rhino, although other appropriate programs would be apparent to a skilled artisan. In certain embodiments, the computer aided design program creates an STL or SLC file to send to the 3D printer for printing. In others, a scanner produces a PLY file to send to the 3D printer.

In some embodiments of the process, the metal piece is tarnished in whole or in part. In certain embodiments, the metal is tarnished by a solution containing sulfur. In some embodiments, the sulfur containing solution comprises Liver of Sulfur, a polysulfide, potassium sulfide, potassium polysulfide, potassium thiosulfate, potassium bisulfide, or a combination thereof. In some of these embodiments, the sulfur containing solution is applied to a copper metal piece, a silver metal piece, or a copper, silver or gold alloy metal piece, including application by brushing or spraying. In others, the metal piece is immersed in the sulfur containing solution. The metal may be immersed once for a predetermined amount of time, or repeated times until the desired degree of tarnishing appears. In certain embodiments of the process, a plurality of metal pieces are immersed at the same time in a tarnishing solution to provide for greater efficiency of the process.

In certain embodiments, the concentration of the sulfur compound or compounds is around 5 grams per 100 mL of water, while in others it is around 2.5 grams per 100 mL, about 7.5 grams per 100 mL or about 10 grams per 100 mL. In some embodiments, the amount of ammonia is about 5 grams per 100 mL, and in some embodiments ammonia can be added in addition to the sulfur compound. Depending on the degree of tarnishing desired, the concentration and temperature of the solution, as well as the amount of time the metal is in contact with the solution, can be varied greatly. A solution near boiling temperatures, for example at 180 degrees Fahrenheit, will rapidly tarnish materials, while a cold or room temperature solution tarnishes the materials at a much slower rate. In certain embodiments, for example, a container holding a tarnishing solution is placed in a water bath or ice bath to control its temperature as desired. In some embodiments, a number of containers are placed in the same water bath to allow multiple pieces to be tarnished in the same way at the same time. This can provide for an efficient process of fine degrees of tarnishment that would be time consuming to carefully perform for many individual pieces. In certain embodiments, a dipping mechanism is used to immerse one or more metal pieces in a tarnishing solution for a defined period, or for repeated defined periods. In some of these embodiments, a user may assess the degree of tarnishment between immersion periods and immerse the metal piece or pieces the number of defined periods needed to obtain the desired degree of tarnishing. In some embodiments, the metal piece or pieces are immersed for one or more periods of 1 second, 2 seconds, 5 seconds, or 10 seconds. In others they are immersed for greater time periods, including but not limited to 15 seconds, 30 seconds, 1 minute, 2 minutes, 5 minutes or 10 minutes. In still other embodiments, longer time periods on the order of hours are used.

By using a lower temperature solution, or having the metal in contact with the solution for shorter periods, intermediate degrees of tarnishment are achieved and a skilled artisan can stop the tarnishing process when desired colors are present. As one representative example, a skilled artisan could use these methods so that the process results in a degree of tarnish that gives a silver metal alloy a green, blue or purple color rather than the grey or black resulting from high degrees of tarnishment. A skilled artisan given the benefit of this disclosure would understand that various combinations of time of exposure, number of exposures, temperature of solution, and/or the concentration of active ingredients can be utilized depending on the characteristics of the chosen metal or alloy and the desired color or degree of tarnishment. In some embodiments using acidic solutions and/or sulfur containing solutions, to halt the tarnishment process, regardless of what the degree of tarnishment is, the process further comprises immersing the metal piece in a basic solution, such as a sodium bicarbonate solution, to prevent further tarnishment.

In other embodiments, a silver alloy is exposed to or immersed in a solution comprising tellurium dioxide and hydrochloric acid, or a solution comprising hydrogen peroxide. In some embodiments, the metal tarnishing solution comprises ammonia. In certain embodiments, the metal is tarnished with a commercially available spray patina applicator. In still other embodiments, an aqueous solution comprising acetic acid, ammonium chloride, and ammonia is applied to a copper metal piece or copper alloy and left for 24 hours, turning the copper light green. In some embodiments, about 30 grams of ammonium chloride and 15 grams of ammonia are present per liter of 10% acetic acid. In other embodiments, an aqueous solution comprising copper nitrate, calcium carbonate and ammonia chloride is applied to a copper metal piece or a copper alloy to turn it green. In certain of these embodiments, about 30 grams of each ingredient is present per liter of water. In still other embodiments, a solution comprising muriatic acid or acetic acid mixed with salt is applied to a copper metal piece or a copper alloy to turn it green. Any known metal tarnishing solution or patina formula that changes the color of a metal can be utilized in the process, however, provided that the contrast in color is sufficient to create a two dimensional barcode that is readable by a scanning device.

In certain embodiments of the process, after the metal is tarnished the tarnish is removed from a portion of the metal piece. In some embodiments the tarnish is removed from the exterior surface so that it forms a contrast with the recessed metal. In some embodiments, the tarnish is removed by polishing or scrubbing the metal piece. In certain embodiments, the tarnish is removed using steel wool, sandpaper, emery paper, baking soda, calcium carbonate or a commercially available polishing compound or polishing pad. In some embodiments, a flame is briefly applied to the exterior surface of the metal to remove the tarnish. In certain embodiments, the metal piece is polished in a rotary or vibratory tumbler, including tumblers using steel shot, to remove the tarnish. In these embodiments, the shot must be larger in diameter than the one or more recesses so that the shot does not remove any tarnish in the recesses. In some embodiments, after the tarnish is removed from the exterior surface the exterior surface is retarnished such that it has a different color than the metal inside the one or more recesses. In one exemplary embodiment of the process, a copper or copper alloy piece is tarnished so that it is light green in color, the tarnish is removed from the exterior surface, and a sulfur containing solution is used to retarnish the copper colored exterior surface to a brown or black color to further emphasize the contrast between the green recessed metal and the now darkened copper of the exterior surface.

In certain embodiments, the process further comprises adding a lacquer to some or all of the article, including selectively adding a lacquer to the one or more recessed areas. In certain embodiments, lacquers may be sprayed or painted on.

By creating and coloring the metal piece in this manner, the process allows the rapid formulation of customized products bearing a desired two dimensional barcode. In embodiments of the process using a 3D printing, the printing and casting of the metal piece can be completed in minutes. In the embodiments where the article is entirely or largely comprised of a single piece of metal, the process provides an extremely durable but visually appealing article that predominantly relies on the visual properties of the metal itself or alloy thereof. By casting the metal itself with the one or more recesses and tarnishing the metal of the recess, the article has appealing tactile feel and a distinctive visual look compared to printed two dimensional barcodes, painted two dimensional barcodes or laser engraved two dimensional barcodes. The process of tarnishing is often extremely rapid, especially when using a hot sulfur containing solution to tarnish the metal piece to a high degree, and multiple metal pieces can be tarnished at the same time even if they all encode distinct information. Conversely, chemical etching processes require a fine degree of control in the application of the etching material and the application of the etchant would have to be unique in order to encode different information. Amongst other advantages, these benefits of the process would be apparent to a skilled artisan given the benefit of this disclosure.

In certain embodiments, the two dimensional barcode encodes information provided by a buyer for a custom article or custom article of jewelry. In these embodiments, the buyer submits content information to be encoded in the two dimensional barcode. In certain embodiments, the content information may be submitted into a website, mobile website, or specialized computer program by a personal computer, mobile phone, or a kiosk set up specifically to take orders for articles and/or articles of jewelry. In certain embodiments, a buyer can submit the content information by text message or email. In some embodiments, the buyer could also enter additional information related to desired features of the article or article of jewelry, including one or more of the dimensions, the shape, the metal or alloy used, and the color or colors to result from the tarnishment.

In these embodiments of the process, the content information is received and converted into a two-dimensional barcode image. In some embodiments, the QR Code Generator of the mobile application “Scan” is used to generate a two dimensional barcode image, but numerous other computer programs and/or mobile applications would be apparent to a skilled artisan. The image is then used to design the mold or directly design the metal piece for the article. In some embodiments, the image is converted to a file for a 3D printer, such as an STL file, that will result in a printed mold that will provide a casted metal piece having one or more recesses that will display the two dimensional barcode encoding the content information. In other embodiments, the file for a 3D printer will directly result in a printed metal piece having the one or more recesses.

In some embodiments of the process, one or more of the steps of receiving the content information and the converting the content information into a two dimensional barcode are performed by an apparatus comprising a computer processor and a tangible computer-readable medium. In these embodiments, the tangible computer-readable medium comprises computer-executable instructions that, when executed by the processor, cause the apparatus to perform at least these steps. In certain embodiments, the apparatus may also perform the step of converting the two dimensional barcode into a file readable by a 3D printer, such as an STL file.

These process descriptions are merely exemplary. In certain embodiments, the process may include additional combinations or substitutions of some or all of the steps described above. Additional and alternative suitable variations, forms and components for the process will be recognized by those skilled in the art given the benefit of this disclosure. Moreover, any of the features discussed in the exemplary embodiments of the article displaying a two dimensional barcode or the article of jewelry may be features of the products made by an embodiment of the process.

What is claimed is:

1. An article displaying a two dimensional barcode comprising:
a metal piece comprising an exterior surface, wherein the exterior surface has an exterior color; and
one or more recesses in the exterior surface, wherein the recessed metal is tarnished such that it has a visual appearance that contrasts with the exterior color;
wherein the one or more recesses are shaped, sized and positioned in the exterior surface such that the contrast between the exterior surface of the metal and the tarnished recess metal visually displays a two-dimensional barcode on the metal piece.

2. The article of claim 1, wherein the metal piece has a depth, and the one or more recesses comprise:
a first side surface forming a ninety degree angle with the exterior surface and extending into the metal piece a distance equal to about a third of the depth of the metal piece; and
a bottom surface forming a ninety degree angle with the first side surface.

3. The article of claim 1, wherein the metal piece is a silver alloy.

4. The article of claim 1, wherein the recessed metal is tarnished to the degree that it is black, grey or a combination thereof in color.

5. The article of claim 1, wherein the metal piece is cast from a mold shaped and sized to provide a casted metal piece comprising the exterior surface and the one or more recesses.

6. The article of claim 1, wherein the exterior surface is flat.

7. The article of claim 1, wherein the two-dimensional barcode is a QR code.

8. An article of jewelry displaying a two dimensional barcode comprising:
a casted metal piece comprising an exterior surface, wherein the exterior surface has an exterior color;
one or more recesses in the exterior surface, wherein the recessed metal is tarnished such that it has a visual appearance that contrasts with the exterior color; and
a wearing attachment connected to the metal piece allowing a person to wear the article of jewelry;
wherein the one or more recesses are shaped, sized and positioned in the exterior surface such that the contrast between the exterior surface of the metal and the tarnished recess metal visually displays a two-dimensional barcode on the metal piece.

9. The article of jewelry of claim 8, wherein the one or more recesses comprise:
a first side surface forming a ninety degree angle with the exterior surface and extending into the metal piece; and
a bottom surface forming a ninety degree angle with the first side surface.

10. The article of jewelry of claim 9, wherein the metal piece has a depth, and the first side surface extends into the metal piece a distance equal to about a third of the depth of the metal piece.

11. The article of jewelry of claim 8, wherein the metal piece is a silver alloy.

12. The article of jewelry of claim 8, wherein the exterior surface is flat.

13. The article of jewelry of claim 8, wherein the recessed metal is tarnished to the degree that it is black, grey or a combination thereof in color.

14. The article of jewelry of claim 8, wherein the recessed metal is tarnished to the degree that it is green, teal, blue, purple, black, grey or a combination thereof in color.

15. A process comprising:
casting metal in a mold shaped and sized to provide a casted metal piece comprising an exterior surface and one or more recesses in its exterior surface, wherein the exterior surface has an exterior color;
tarnishing the metal piece; and
removing the tarnish from the non-recessed exterior surface such that the recessed metal has a visual appearance that contrasts with the color of exterior surface;
wherein the one or more recesses are shaped, sized and positioned in the exterior surface such that the contrast between the exterior surface of the metal and the tarnished recess metal visually displays a two-dimensional barcode on the metal piece.

16. The process of claim 15, further comprising:
receiving content information from a buyer; and
converting the content information into a two-dimensional barcode;
wherein the metal is cast in a mold shaped and sized such that, at the completion of the process, the metal piece will visually display a two-dimensional barcode encoding the content information.

17. The process of claim 15, further comprising printing the mold from a 3D printer.

18. The process of claim 15, wherein the metal piece is tarnished by exposing it to a solution containing sulfur.

19. The process of claim 15, wherein the two-dimensional barcode is a QR code.

20. The process of claim 15, wherein the metal piece has a depth, and the one or more recesses comprise:
a first side surface forming a ninety degree angle with the exterior surface and extending into the metal piece a distance equal to about a third of the depth of the metal piece; and
a bottom surface forming a ninety degree angle with the first side surface.
